(19) United States
(12) Patent Application Publication
(10) Pub. No.: US 2016/0222942 A1
(43) Pub. Date: Aug. 4, 2016

(54) Wind Turbine Having a Wing-Shaped Turbine Blade

(71) Applicant: Jesse Fox, Houston, TX (US)

(72) Inventor: Jesse Fox, Hoston, TX (US)

(21) Appl. No.: 14/991,999

(22) Filed: Jan. 10, 2016

Related U.S. Application Data
(60) Provisional application No. 62/101,648, filed on Jan. 9, 2015.

(51) Int. Cl. F03D 3/00; F03D 9/00; F03D 3/06

(52) U.S. Cl. CPC F03D 3/005; F03D 3/064; F03D 9/002

(57) ABSTRACT

The present invention provides a wind turbine with two overlapping wing shaped turbine blades mounted about a rotational axis. The wing shaped turbine blades are shaped so that wind from an outer surface of a first leading wing shaped turbine blade flows into an inner surface of a trailing wing shaped turbine blade.

### RELATED APPLICATIONS

This application takes priority from U.S. Provisional Patent Application Ser. No. 62/101,648 filed on Jan. 9, 2015 by Jesse Fox and entitled “A Wind Turbine”, which is hereby incorporated by reference herein in its entirety.

### BACKGROUND OF THE INVENTION

Wind turbines are well known in the art. Wind turbines work the opposite of a fan. Instead of using electricity to make wind, like a fan, wind turbines use wind to make energy such as electricity and mechanical energy. The wind turns the turbine blades, which spin a shaft, which connects to a generator and makes electricity. Wind is a form of solar energy and is a result of the uneven heating of the atmosphere by the sun, the irregularities of the earth's surface, and the rotation of the earth. Wind flow patterns and speeds vary greatly across the United States and are modified by bodies of water, vegetation, and differences in terrain. Humans use this wind flow, or motion energy, for many purposes: sailing, flying a kite, and even generating electricity.

The terms wind energy or wind power describe the process by which the wind is used to generate mechanical power or electricity. Wind turbines convert the kinetic energy in the wind into mechanical power. This mechanical power can be used for specific tasks (such as grinding grain or pumping water) or a generator can convert this mechanical power into electricity.

### FIELD OF THE INVENTION

The field of the present invention is wind turbines.

### SUMMARY OF THE INVENTION

The present invention provides a wind turbine having two overlapping wing-shaped turbine blades mounted about a central rotational axis for the wind turbine. The wing-shaped turbine blades are shaped so that, wind that blows on an outer convex surface of a leading wing-shaped turbine blade, flows smoothly over the outer convex surface and into an inner concave surface of a trailing wing-shaped turbine blade on the wind turbine during a portion of each rotation of the wind turbine.

### BRIEF DESCRIPTION OF THE DRAWINGS

FIG. 1 depicts a schematic representation of an illustrative embodiment of the present invention;

FIG. 2 is a schematic depiction of wind turbulence caused by a semicircle shaped turbine blades;

FIG. 3 is a schematic depiction of smooth and directed wind flow caused by an illustrative embodiment having substantially wing-shaped turbine blades;

FIG. 4 depicts a graphical representation of a wing-shaped turbine blade arc;

FIG. 5 illustrates a wing-shaped turbine bladesupporting structure of vertical ribs and horizontal ribs constructed to form wing-shaped turbine blades about a center structural member; and

FIG. 6 illustrates a skin applied over the support structure ribs and to form the outer convex shaped surface and the inner concave surface of wing-shaped turbine blades.

### DETAILED DESCRIPTION AN ILLUSTRATIVE EMBODIMENT OF THE INVENTION

In a particular embodiment of the invention, a wind turbine is disclosed having two wing-shaped turbine blades mounted around a central axis of rotation or rotational axis for the wind turbine. For purposes of the present disclosure the term “wing-shaped turbine blade” is used to mean a turbine blade having a curved convex exterior surface and a curved concave interior surface wherein the convex and concave curved surfaces have an decreasing radius of curvature as seen moving along the wing-shaped turbine blade away from the center of rotation for the wind turbine using the wing-shaped turbine blades. Likewise, the convex and concave curved surfaces have an increasing radius of curvature as seen moving along the wing-shaped turbine blade from the distal end of the wing shaped turbine blade toward the center of rotation for the wind turbine using the wing-shaped turbine blades. The wing-shaped turbine blades are mounted around the center rotational axis of the wind turbine so that the wing-shaped turbine blades overlap each other at the central rotational axis of the wind turbine using the wing-shaped turbine blades. In another particular embodiment, each wing-shaped turbine blade has an outer surface convex shape and an inner surface convex shape. The wing-shaped turbine blades are each designed to create lift as the wind blows over the exterior convex surface of each wing. The wing-shaped surfaces of the wing-shaped turbine blades generate lift substantially throughout each complete revolution of the turbine as well as producing the fluid air flow vectoring of wind over the outer surface of a leading wing-shaped turbine blade into the inside concave surface of a trailing wing-shaped turbine blade. The wing-shaped turbine blades surfaces also generates torque substantially throughout each complete revolution of the turbine as wind blows over the convex surface of the leading wing-shaped turbine blade and into the concave portion of the trailing wing-shaped turbine blade. The wing-shaped turbine blades causes the rotation of a wind turbine using the wing-shaped turbine blades to restart from any static point using wind from any direction and give a wind turbine using the wing-shaped turbine blades greater efficiency overall. The outer shape of the wing-shaped turbine blade enables a wind turbine using the wing-shaped turbine blades to restart the wind turbine rotating in a wind when stopped after wind had stopped blowing. The wing-shaped turbine blades also provide steadier torque and rotational force during rotation of a wind turbine using the wing-shaped turbine blades.

A particular illustrative embodiment of present invention provides a self-starting vertical wind turbine with two overlapping wing-shaped turbine blades mounted on a vertical central rotational axis. The wing-shaped turbine blades are shaped so that wind from an outer surface of a leading wing-shaped turbine blade flows into an inner surface of a trailing wing-shaped turbine blade. Wind blows across the axis from the outer surface of a leading wing to the inner surface of a trailing wing.

In another particular embodiment, the turbine axis is positioned vertical with respect to the earth' surface and placed in position to rotate about the vertical rotational axis and the wind blows horizontally across the wind turbine's wing-shaped turbine blades. In another particular embodiment of the present invention the rotational axis is positioned horizontally with respect to the earth's surface. In another particular embodiment of the present invention the rotational axis of the wind turbine is positioned at an angel with respect to a vertical and horizontal direction with respect to the earth's surface. The wing-shaped turbine blades enable the wind turbine using the wing-shaped turbine blades to restart spinning again from a stationary position when the wind starts blowing again. In a particular embodiment of the invention, the wind blows across the outer convex surface of each wing-shaped turbine blade to create lift and to vector wind off of the outer convex surface of the a leading turbine wing-shaped turbine blades to the inner concave surface of a trailing wing-shaped turbine blade to create more rotational spin due to the wind blowing and to help get rotation of a wind turbine using the wing-shaped turbine blades started again after the wind has stopped. Alternative embodiments of the invention contemplates a wide variety of structural adaptations to the invention.

In a particular illustrative embodiment, a wind turbine is disclosed, the wind turbine including but not limited to a first wing-shaped turbine blade mounted perpendicular to a rotational axis, the first wing-shaped turbine blade having an outer convex surface and an inner concave surface, the first wing-shaped turbine blade having an inner wing edge overlapping the rotational axis; and a second wing-shaped turbine blade mounted perpendicular to the rotational axis, the second wing-shaped turbine blade having an outer convex surface and an inner concave surface, the second wing-shaped turbine blade having an inner wing edge overlapping the rotational axis, wherein the inner wing-shaped turbine blade edge of first cupped wing and inner wing vertical edge of second wing-shaped turbine blade overlap each other and the rotational axis. Each wing has an inner edge which is closest to the rotational axis and an outer edge that is further from the rotational axis. Each wing-shaped turbine blade has a bottom edge closest to a first end of the wind turbine and a top edge that is closest to a second end of the turbine. In a vertical turbine, the lower edge of the wing-shaped turbine blade is closer to the ground and the upper edge of the wing-shaped turbine blade is farther from the ground than the lower edge.

In another particular illustrative embodiment, of the wind turbine, the outer convex surface of the first wing-shaped turbine blade is shaped to cause wind to flow from the outer convex surface over the vertical edge of the first wing-shaped turbine blade to the inside concave surface of the second wing-shaped turbine blade during rotation of a wind turbine using the wing-shaped turbine blades in a wind. In another particular illustrative embodiment, of the wind turbine, the outer convex surface has a substantially wing shaped arc shape. Variations in the wing-shaped turbine blades may be provide in other particular embodiments of the invention. In another particular embodiment, the wing-shaped turbine blade is shaped to provide less lift during higher wind speed conditions. In another particular embodiment, the wing-shaped turbine blade is shaped to provide more lift during lower wind speed conditions. In another particular illustrative embodiment of the invention, the outer the wing-shaped turbine blade further includes, but is not limited to a wing support structure including but not limited to ribs forming the wing-shaped turbine blade; and a skin applied over the ribs forming the wing-shaped turbine blade. In another particular illustrative embodiment of the present invention, the wing support structure is connected to an electrical generator for generating electrical energy during wing support structure rotation. In another particular illustrative embodiment of the wind turbine, the outer the wing-shaped turbine blade further includes but is not limited to a wing mounting member, wherein the first and second wing-shaped turbine blades are attached to the wing mounting member. In another particular illustrative embodiment of the wind turbine, the wing mounting member is a support rotationally mounted in a perpendicular plane with respect to the rotational axis of a wind turbine using the wing-shaped turbine blades. In another particular illustrative embodiment of the invention, the wing mounting member comprises a disk, wherein a lower edge of the first wing and a lower edge of the second wing are attached to the disk. In another particular illustrative embodiment of the wind turbine, the wing mounting member further comprises an upper disk, wherein an upper edge of the first wing and an upper edge of the second wing are attached to the upper disk. In another particular illustrative embodiment of the invention, the rotational axis of the wind turbine is vertical with respect to the surface of the earth. In another particular illustrative embodiment of the invention, the wind turbine includes but is not limited to an electromechanical generator connected to the wind turbine that converts rotational motion about the rotational axis into electrical energy. In another particular illustrative embodiment of the invention, the wind turbine includes but is not limited to a bearing connected to the wind turbine that converts rotational motion about the rotational axis into mechanical energy. In another particular illustrative embodiment of the invention, the wind turbine, the wind turbine that causes rotational motion in a wind with converting the rotational axis into electrical or mechanical energy.

In another particular embodiment of the invention, a method for making a wind turbine is disclosed, the method includes but not limited to attaching a first wing-shaped turbine blade to a wing mounting member so that the wing-shaped turbine blade is mounted perpendicular to a rotational axis, the first wing-shaped turbine blade having an outer convex surface and an inner concave surface, the wing-shaped turbine blade having an inner wing edge overlapping the rotational axis; and attaching a second wing-shaped turbine blade mounted perpendicular to the rotational axis, the second wing-shaped turbine blade having an outer convex surface and an inner concave surface, the second wing-shaped turbine blade having an inner wing edge overlapping the rotational axis, wherein the inner wing edge of first wing-shaped turbine blade and inner wing vertical edge of a second wing-shaped turbine blade overlap each other and the rotational axis. In another particular illustrative embodiment of the method, the outer convex surface of the first wing-shaped turbine blade is shaped to cause wind to flow from the outer convex surface of the first wing-shaped turbine blade, over the vertical edge of the first cupped wing to the inside concave surface of the second wing-shaped turbine blade, while the wing-shaped turbine blades are rotating in the wind.

In another particular illustrative embodiment of the method, the method further includes but is not limited to attaching the first and second wing-shaped turbine blades to a wing mounting member. In another particular illustrative embodiment of the method, the wing mounting member is a support rotationally mounted in a perpendicular plane with respect to the rotational axis. In another particular illustrative embodiment of the method, the wing mounting member comprises a lower disk, wherein a lower edge of the first wing-shaped turbine blade and a lower edge of the second wing-shaped turbine blade are attached to the lower disc. In another particular illustrative embodiment of the method, the method further includes but is not limited to an upper edge of the first wing-shaped turbine blade and an upper edge of the second wing-shaped turbine blade are attached to the upper disc. In another particular illustrative embodiment of the method, the method further includes but is not limited to connecting a member between the first and second wing-shaped turbine blades to stabilize the wing-shaped turbine blades with respect to the rotational axis. In another particular illustrative embodiment of the method, the rotational axis of the wind turbine using the wing-shaped turbine blades is vertical. In another particular illustrative embodiment of the method, the method further includes but is not limited to converting rotational motion around the rotational axis into electrical energy using an electromechanical generator connected to the wind turbine that converts rotational motion about the rotational axis into electrical energy. In another particular embodiment, the wings are supported by the wing support structure, wherein the wing support structure is rotationally attached to generator for generating electricity.

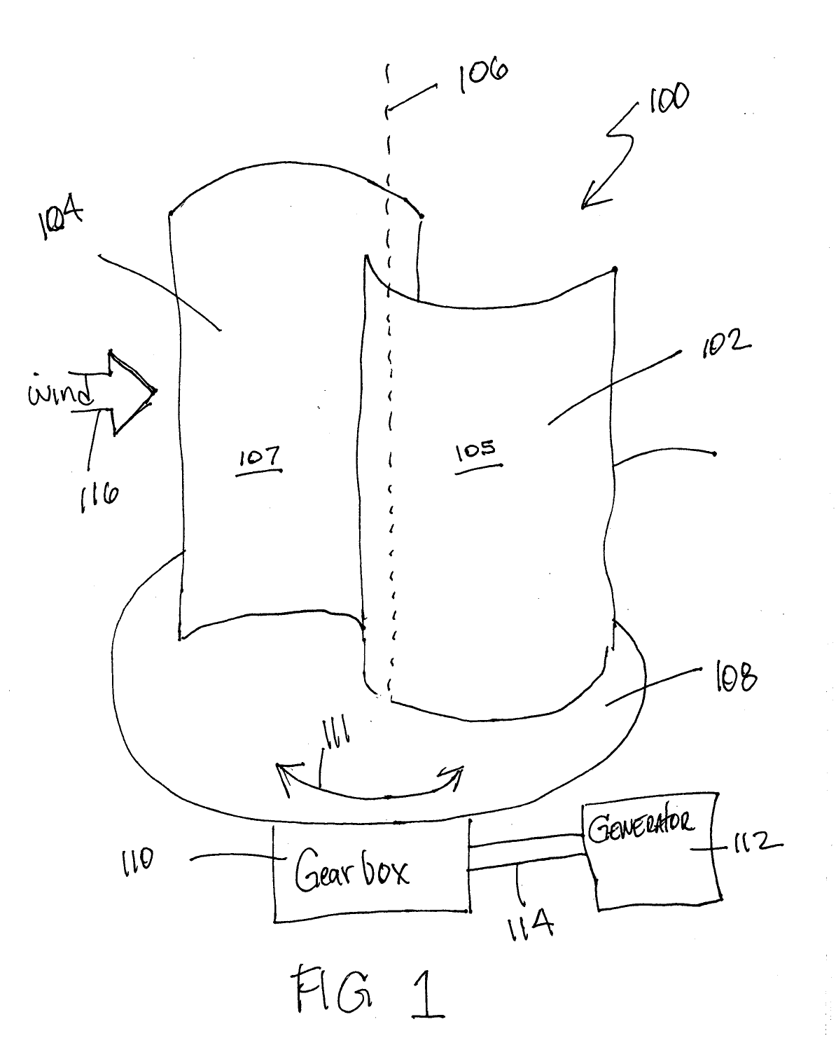

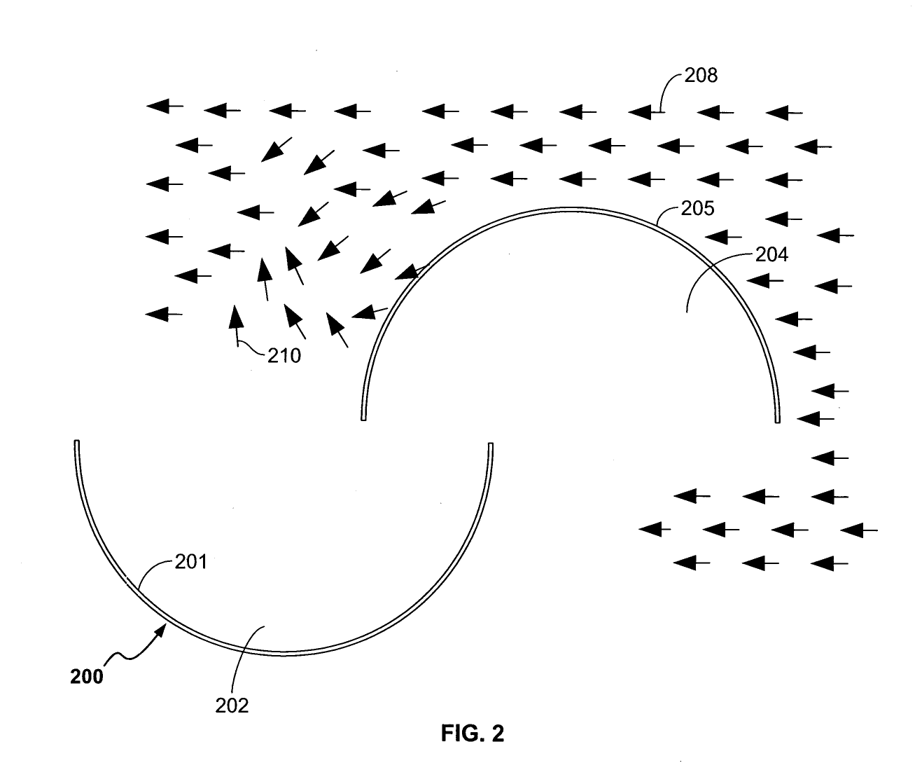

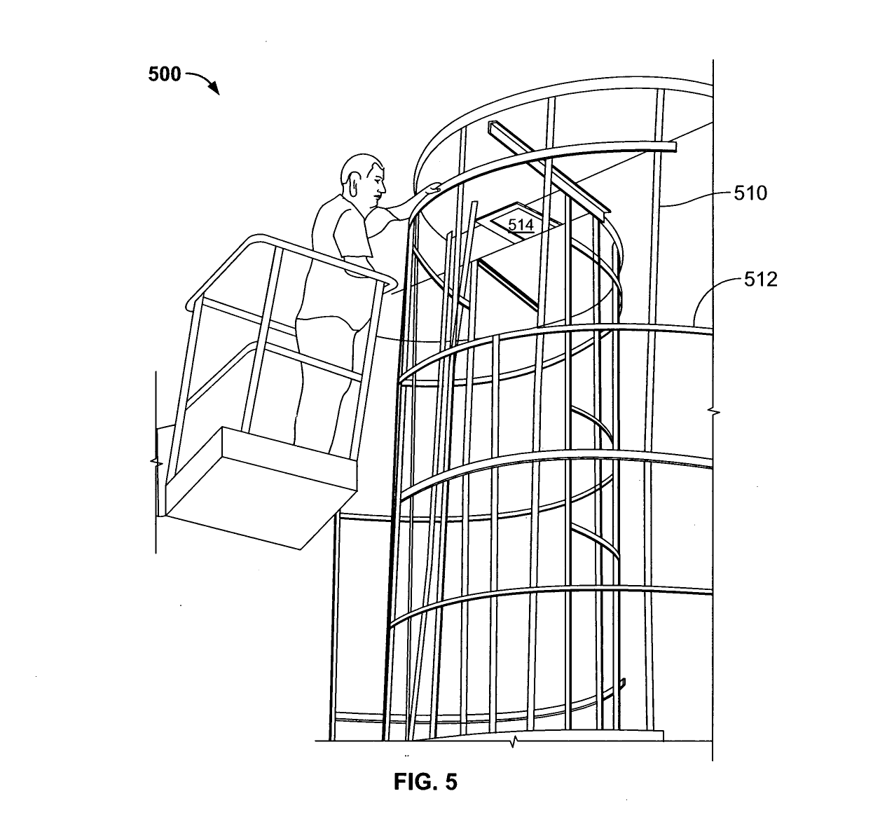

Turning now to FIG. 1, FIG. 1 depicts an illustrative embodiment 100 of the invention. As shown in FIG. 1, in a particular illustrative embodiment a first wing-shaped turbine blade 102 and a second wing-shaped turbine blade 104 are fixed about a rotational axis 106 on a rotating wing mounting member 108. Wing mounting member allows rotation 111. In one particular embodiment, the wing mounting member is attached to a gearbox 110. In another particular embodiment, the wing-shaped turbine blades are fixed using ribs as shown in FIG. 5. As shown in FIG. 2, the gear box is attached to an electrical generator 112. In another particular embodiment, the gear box is attached to a mechanical energy generator. In another particular embodiment, the wind turbine does not have a gear box and spins without being coupled to an electrical or mechanical energy generator. In another particular embodiment, the gear box is a bearing. As wind 116 blows across the first wing 102 and the second wing 104, a rotational force is created by the wing-shaped turbine blades causing the wing-shaped turbine blades to rotate about rotational axis 106. This rotation of the wing-shaped turbine blades causes rotation of the gear box 110 which causes the shaft 114 to rotate. The shaft is connected to the electrical generator causing the generator's rotator to spin or rotate, thereby generating electricity output from the electric generator 112. In another embodiment the electrical generator is a mechanical energy generator. Each wing-shaped turbine blade has a curved outer convex side 105 and a curved inner concave side 107. In another embodiment, a wing support structure shown in FIG. 5 is connected to the electrical generator causing the generator's rotator to spin or rotate, thereby generating electricity output from the electric generator 112. In another embodiment a second wing mounting member (not shown) is attached at opposite end of the wings.

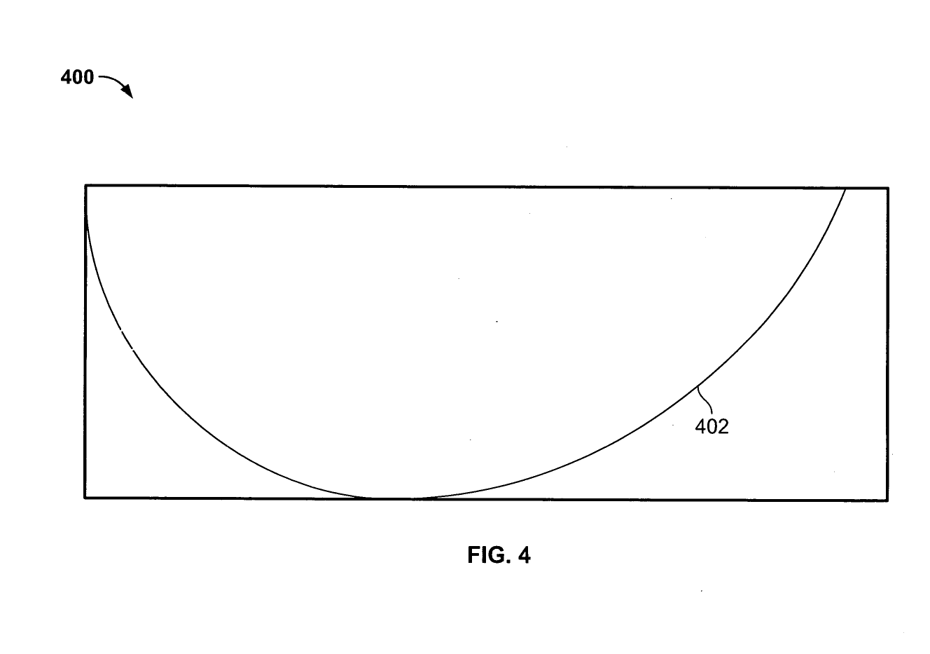

FIG. 4 illustrates a diagram 600 of an arc 602. In one particular embodiment, a shape substantially similar to a portion of this arc can be used as the shape the wing-shaped turbine blades 102 and 104. In other embodiments, other wing shapes are used for the wing-shaped turbine blades 102 and 104.

Turning now to FIG. 2, a depiction 402 of wind turbulence caused by semi-circular shaped turbine blades is illustrated. As shown in FIG. 2, semi-circular shaped turbine blades 404 and 402 are semicircle shaped. Wind 408 that blows across the top outside surface 405 of semi-circular shaped turbine blade 404 changes direction becomes turbulent 410. The semi-circular shaped turbine blade creates turbulence in the air 408 blowing across the outer surfaces of the semi-circular shaped turbine blades. The direction of the wind flow after blowing across and over the convex shaped top 405 of semi-circular blade 404 is multidirectional and does not flow efficiently into the inside interior concave surface 410 of the trailing semi-circular shaped turbine blade 402.

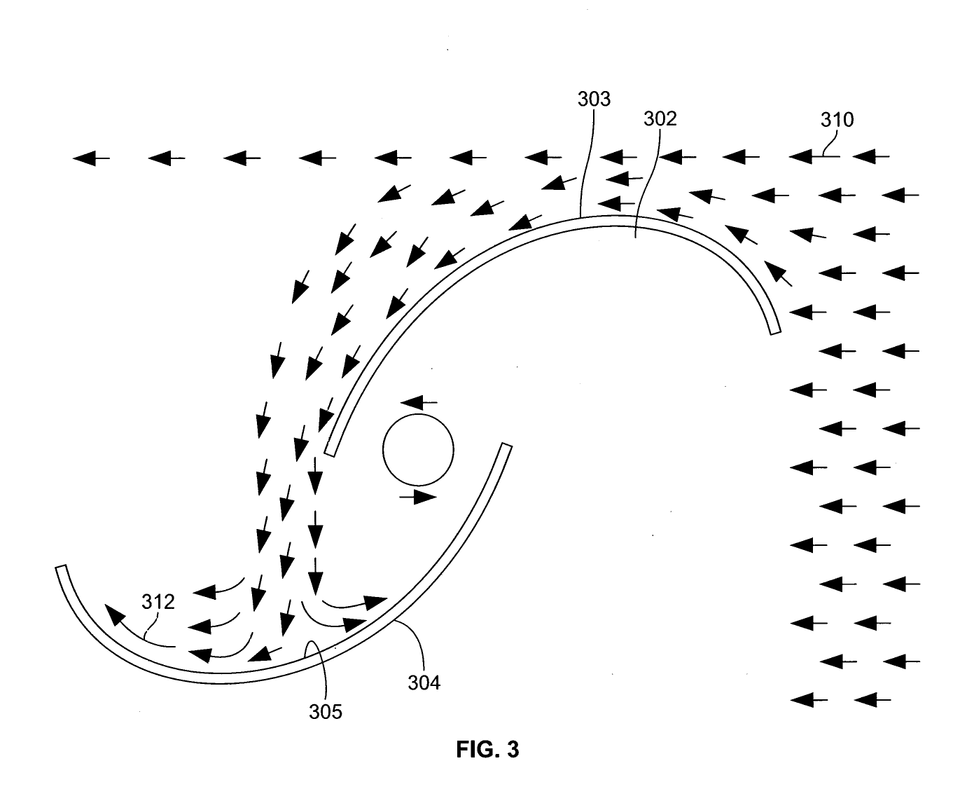

Turning now to FIG. 3, in a particular illustrative embodiment, semi-circular shaped turbine blades 502 and 504 are shaped having a decreasing radius of curvature of the semi-circular shaped turbine blade away from the center of rotation 301. As shown in FIG. 3, wind 510 that blows across the top 503 of semi-circular shaped turbine blades 502 is less turbulent than shown in FIG. 2 and flows substantially smoothly from the outside surface 503 of the leading wing shaped turbine blade into the inside concave surface 505 of wing shaped turbine blade 504 as shown by arrows 512. The direction of the wind flow after blowing across the top 405 of wing shaped turbine blade 404 is multidirectional and does not flow efficiently into the inside 410 of the trailing wing 402.

Turning now to FIG. 4, FIG. 4 depicts a schematic depiction of a shape 602 for a wing-shaped turbine blade suitable for use in a particular embodiment of the invention disclosed herein.

Turning now to FIG. 5, as shown in FIG. 5, in a particular illustrative embodiment, a wing supporting structure 700 of vertical ribs 710 and horizontal ribs 712 is constructed to form wings 102 and 104 about a center structural member 714. As shown in FIG. 7, there is no center post. The wing supporting structure improves the stiffness of the wings. The wing support structure allows scaling up in size of the design shown in a particular illustrative embodiment. There is also no center post, which eliminates an obstruction form the rotational center of the wings and allows unobstructed wind flow between wings through the center of the across the rotational axis.

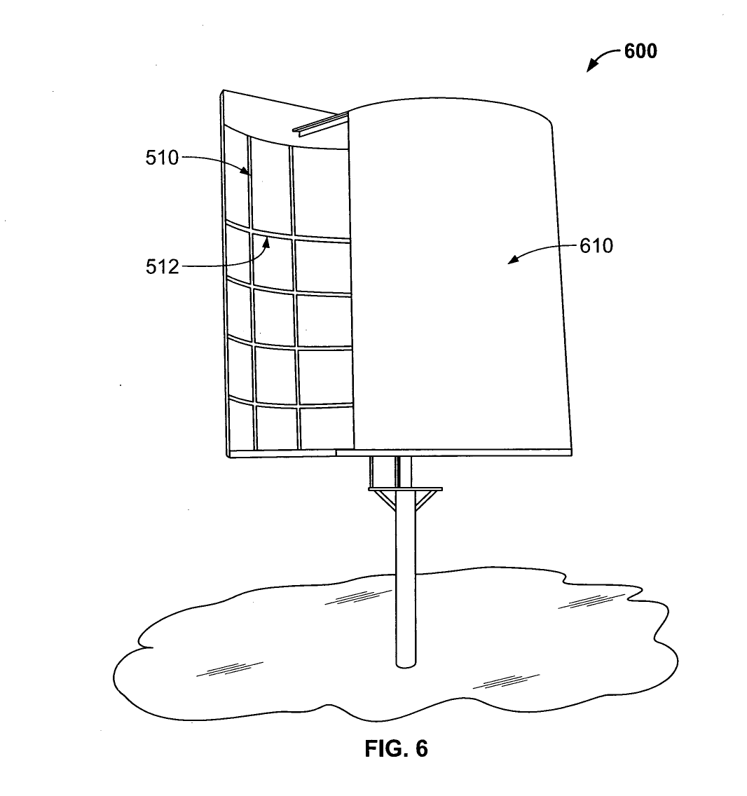

Turning now to FIG. 6, as shown in FIG. 6, in a particular embodiment of the invention 800, a skin 810 is applied over the support structure ribs 710 and 712 to form the outer convex shaped surface and the inner concave surface of wing shaped turbine blades 102 and 104. In another embodiment the wing shaped turbine blade is a 3D printed shape. In another embodiment the wing shaped turbine blade is a plastic molded wing.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. The figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A wind turbine, the wind turbine comprising:
a first wing shaped turbine blade mounted perpendicular to a rotational axis, the first wing shaped turbine blade having a substantially curved outer convex surface and a substantially curved inner concave surface, the first wing shaped turbine blade having an inner wing edge overlapping the rotational axis; and
a second wing shaped turbine blade mounted perpendicular to the rotational axis, the second cupped wing having an outer convex surface and an inner concave surface, the second cupped wing having an inner wing edge overlapping the rotational axis, wherein the inner wing edge of first cupped wing and inner wing vertical edge of second cupped wing overlap each other and the rotational axis.

2. The wind turbine of claim 1, wherein the outer convex surface of the first wing shaped turbine blade is shaped having a decreasing radius of curvature away from the rotational axis to cause wind to flow over the outer convex surface of the first wing shaped turbine blade to the inside concave surface of the second wing shaped turbine blade while rotating in a wind.

3. The wind turbine of claim 1, wherein the outer convex surface of the first wing shaped turbine blade has a substantially arc shape.

4. The wind turbine of claim 3, the wind turbine further comprising:
a wing shaped turbine blade support structure comprising ribs; and
a skin applied over the ribs, forming the wing shaped turbine blade.

5. The wind turbine of claim 1, the turbine further comprising:
a wing mounting member, wherein the first and second wing shaped turbine blades are attached to the wing mounting member.

6. The wind turbine of claim 5, wherein the wing mounting member is rotationally mounted in a perpendicular plane with respect to the rotational axis.

7. The wind turbine of claim 5, wherein the wing mounting member comprises a disk, wherein a lower edge of the first wing shaped turbine blade and a lower edge of the second wing shaped turbine blade are attached to the disk.

8. The wind turbine of claim 7, wherein the wing mounting member further comprises an upper disk, wherein an upper edge of the first wing shaped turbine blade and an upper edge of the second wing are attached to the upper disk.

9. The wind turbine of claim 1, wherein the rotational axis is vertical with respect to the surface of the earth.

10. The wind turbine of claim 1, further comprising an electromechanical generator connected to the wind turbine that converts rotational motion about the rotational axis into electrical energy.

11. A method for making a wind turbine, the wind turbine comprising:
attaching a first wing shaped turbine blade to a wing mounting member so that the first wing shaped turbine blade is mounted perpendicular to a rotational axis of the wind turbine, the first cupped wing having an outer convex surface and an inner concave surface, the first cupped wing having an inner wing edge overlapping the rotational axis; and
attaching a second wing shaped turbine blade so it is mounted perpendicular to the rotational axis, the second wing shaped turbine blade having an outer convex surface and an inner concave surface, the second wing shaped turbine blade having an inner wing edge overlapping the rotational axis, wherein an inner wing vertical edge of wing shaped turbine blade and an inner wing vertical edge of second wing shaped turbine blade overlap each other and the rotational axis.

12. The method of claim 11, wherein the outer convex surface of the first wing shaped turbine blade is shaped to cause wind to flow over the outer convex surface of the first cupped wing to the inside concave surface of the second wing shaped turbine blade while rotating in a wind.

13. The method of claim 11, wherein the outer convex surface is an elliptical shape.

14. The method of claim 11, the method further comprising:
attaching the first and second wing shaped turbine blades to a wing mounting member.

15. The method of claim 14, wherein the wing mounting member is a support rotationally mounted in a perpendicular plane with respect to the rotational axis.

16. The method of claim 15, wherein the wing mounting member comprises a lower disc, wherein a lower edge of the first wing and a lower edge of the second wing are attached to the lower disc.

17. The method of claim 16, wherein the wing mounting member further comprises an upper disc, wherein an upper edge of the first wing shaped turbine blade and an upper edge of the second wing shaped turbine blade are attached to the upper disc.

18. The method of claim 15, further comprising:
connecting a rigid member attached between the first and second wing shaped turbine blades to stabilize the wings with respect to the rotational axis.

19. The method of claim 11, wherein the rotational axis is vertical.

20. The method of claim 11, further comprising:
converting rotational motion around the rotational axis into electrical energy using an electromechanical generator connected to the wind turbine that converts rotational motion about the rotational axis into electrical energy.
